(19) United States
(12) Patent Application Publication
(10) Pub. No.: US 2002/0181878 A1
(43) Pub. Date: Dec. 5, 2002

(54) Dynamic chromatic dispersion control using coupled optical waveguides

(76) Inventors: Victor M. Schneider, Painted Post, NY (US); Daniel A. Nolan, Corning, NY (US)

Correspondence Address: VOLENTINE FRANCOS, PLLC, SUITE 150, 12200 SUNRISE VALLEY DRIVE, RESTON, VA, 20191, US

(21) Appl. No.: 09/983,771

(22) Filed: Oct. 25, 2001

Related U.S. Application Data
(60) Provisional application No. 60/295,054, filed on May 31, 2001.

(51) Int. Cl. G02B 6/26; G02B 6/28

(52) U.S. Cl. 385/50; 385/27; 385/39; 385/24

(57) ABSTRACT

According to an exemplary embodiment of the present invention, an apparatus for dynamically controlling chromatic dispersion in an optical signal includes a coupled waveguide structure, and a device which alters an index of refraction of the coupled waveguide structure to effect a change in the chromatic dispersion.

According to another exemplary embodiment of the present invention, a method for dynamically controlling chromatic dispersion includes providing a coupled waveguide structure and selectively altering an index of refraction profile of coupled waveguide structure to effect a change in the chromatic dispersion in an optical signal.

### CROSS-RELATED TO RELATED APPLICATIONS

The present invention is related to and claims priority under 35 U.S.C. § 119(e) from U.S. Provisional Patent Application Serial No. 60/295,054, entitled “Dispersion Dynamic Control Via Thermal and/or Optical Variation of Supermode Propagation”, filed May 31, 2001. The present invention is also related to U.S. patent application Ser. No. (Atty. Docket No.: CRNG.027/SP01-288) entitled “Chromatic Dispersion Control Method and Apparatus”, filed on even date herewith. The disclosures of the above-captioned provisional application and utility patent application are specifically incorporated by reference herein and for all purposes.

### FIELD OF THE INVENTION

The present invention relates generally to optical communications, and particularly to a method and apparatus for dynamically controlling chromatic dispersion in optical communications systems.

### BACKGROUND OF THE INVENTION

Optical transmission systems, including optical fiber communication systems, have become an attractive alternative for carrying voice and data at high speeds. In optical transmission systems, waveform degradation due to chromatic dispersion in the optical transmission medium can be problematic, particularly as transmission speeds continue to increase.

Chromatic dispersion results from the fact that in transmission media such as glass optical waveguides, the higher the frequency of the optical signal, the greater the refractive index. As such, higher frequency components of optical signals will “slow down,” and contrastingly, lower frequency signals will “speed-up.” In single mode optical fiber, chromatic dispersion results from the interplay of two underlying effects, material dispersion and waveguide dispersion. Material dispersion results from the non-linear dependents upon wavelength of the refractive index, and the corresponding group velocity of the material, illustratively doped silica. Waveguide dispersion results from the wavelength dependent relationships of the group velocity to the core diameter and the difference in the index of refraction between the core and the cladding. Moreover, impurities in the waveguide material, mechanical stress and strain, and temperature effects can also affect the index of refraction, further adding to the ill-effects of chromatic dispersion.

In digital optical communications, where the optical signal is ideally a squarewave, bit-spreading due to chromatic dispersion can be particularly problematic. To this end, as the “fast frequencies” slow down and the “slow frequencies” in the signal speed up as a result of chromatic dispersion, the shape of the waveform can be substantially impacted. The effects of this type of dispersion are a spreading of the original pulse in time, causing it to overflow in the time slot that has already been allotted to another bit. When the overflow becomes excessive, intersymbol interference (ISI) may result. ISI may result in an increase in the bit-error rate to unacceptable levels.

As can be appreciated, control of the total chromatic dispersion of transmission paths in an optical communication system is critical to the design and construction of long-haul, and high-speed communications systems. To achieve this, it is necessary to reduce the total dispersion to a point where its contribution to the bit-error rate of the signal is acceptable. In commonly used dense wavelength division multiplexed (DWDM) optical communications systems, there may be 40 wavelength channels or more, having channel center wavelength spaced approximately 0.8 nm to approximately 1.0 nm apart. Illustratively, a 40-channel system could have center wavelengths in the range of approximately 1530 nm to approximately 1570 nm. As can be appreciated, controlling chromatic dispersion in such a system, and in a dynamic manner, can be difficult.

One technique to dynamically compensate for chromatic dispersion includes the use of optical gratings such as chirped fiber Bragg gratings. The chirped fiber Bragg gratings are made by exposing specially doped fiber to an interference pattern of intense ultraviolet wavelength. Chirping referrers to an increase in the period of the index variation as a function of distance along the fiber.

While compensation for chromatic dispersion through the use of chirped fiber Bragg gratings (FBG) and other types of gratings have shown promise, these systems tend to be relatively complex and the cost of each element is exceedingly high.

Accordingly, what is needed is a method and apparatus for controlling chromatic dispersion for use in optical communications systems, which overcomes at least the drawbacks referenced in detail above.

### SUMMARY OF THE INVENTION

According to an exemplary embodiment of the present invention, an apparatus for dynamically controlling chromatic dispersion in an optical signal includes a coupled waveguide structure, and a device which alters an index of refraction of the coupled waveguide structure to effect a change in the chromatic dispersion.

According to another exemplary embodiment of the present invention, a method for dynamically controlling chromatic dispersion includes providing a coupled waveguide structure and selectively altering an index of refraction profile of coupled waveguide structure to effect a change in the chromatic dispersion in an optical signal.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a graphical representation of the refractive index versus radius of a coupled waveguide structure in accordance with an exemplary embodiment of the present invention.

FIG. 2 is a graphical representation of the refractive index versus radius of a coupled waveguide structure in accordance with an exemplary embodiment of the present invention.

FIG. 3 is a graphical representation of the chromatic dispersion versus wavelength in accordance with an exemplary embodiment of the present invention.

FIG. 4 is a graphical representation of the chromatic dispersion versus wavelength in accordance with an exemplary embodiment of the present invention.

FIG. 5 is a schematic block diagram of a dynamic dispersion control apparatus in accordance with an exemplary embodiment of the present invention.

FIG. 6 is a schematic block diagram of a dynamic dispersion control apparatus in accordance with an exemplary embodiment of the present invention.

FIG. 7 is a schematic block diagram of a dynamic dispersion control apparatus in accordance with an exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, as described in conjunction with exemplary embodiments, the present invention relates to a method and apparatus for dynamically controlling chromatic dispersion and/or dispersion slope in an optical signal by altering index of refraction profile of a coupled optical waveguide structure. In accordance with one exemplary embodiment, the index of refraction profile is altered by thermally controlling the coupled waveguide structure. In accordance with another exemplary embodiment of the present invention, the index of refraction profile is altered by introducing optical radiation (e.g. via a secondary optical source such as a laser) to the optical waveguide. The change in the index of refraction profile changes the optical propagation characteristics of supermodes which are excited in the coupled waveguide structure.

Control of chromatic dispersion and/or dispersion slope is effected dynamically by controlled alteration of the index of refraction and the dispersion characteristics of supermodes. Further details of supermode propagation and the dispersion characteristics thereof in coupled waveguide structures are described herein. Advantageously, the resultant chromatic dispersion and/or dispersion slope present in an optical signal may be adjusted to zero, positive values, or negative values by an illustrative method and apparatus of the present invention

It is noted, however, that these techniques to alter the index of refraction profile of the optical waveguide in a controlled manner are merely illustrative, and other techniques for altering the index of refraction profile of the optical waveguide in accordance with an exemplary embodiment of the present invention may be used. For example, an external mechanical force applied to the coupled waveguide structure can also induce refractive index changes. Moreover, the pumping of the secondary laser at a Raman resonance where the signal is amplified also can lead to substantial changes in the index of refraction profile in the coupled waveguide structure. Additionally, the use of electrooptic and acoustooptic glasses or crystals in the coupled waveguide structure can lead to control of the index of refraction profile via application of an electric field or an acoustic wave to the waveguide, respectively.

As described briefly above, coupled waveguide structures capable of supporting supermodes may be used in carrying out the present invention. Of course, a variety of coupled waveguides structures may be used. These coupled waveguide structures may be, but are not necessarily, dispersion compensating waveguides. For purposes of illustration, and not limitation, examples of coupled waveguides for use in connection with exemplary embodiments of the present invention are described presently.

In accordance with an exemplary embodiment of the present invention, the coupled waveguide structure is an optical fiber having a central core and a ring circumferentially thereabout. The core and the ring have indices of refraction which are greater than the index of refraction of a cladding layer between the core and the ring, and of a cladding layer that surrounds the exterior of the ring.

The core and ring coupled waveguide structure may have a variety of configurations and may be composed of a variety of materials. For example, an optical fiber containing more than one ring disposed circumferentially about a core may be used. Cladding material similar to that described in connection with the single ring fiber would be disposed between the successive rings. Moreover, the cladding layer(s) may be comprised of a plurality of layers of the same or differing materials. It is further noted that the coupled waveguide structure may be dispersion compensating fiber such as are described in U.S. Pat. Nos. 5,361,319 and 5,999,679 both to Antos, et al., and assigned to the assignee of the present invention. The disclosures of the above referenced patents to Antos, et. al are specifically incorporated by reference herein.

Additionally, planar coupled waveguides which can support supermodes may be used. To wit, multiple planar waveguides in a substrate may be used, such as those used in integrated optics. Of course, a variety of structures and materials may be used to achieve this end.

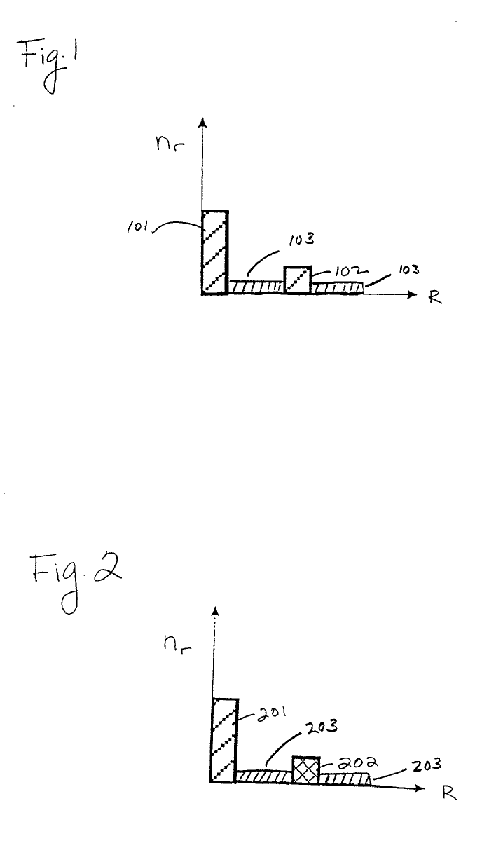

Turning to FIG. 1, a cross-sectional profile of the refractive index versus radius of an illustrative coupled waveguide structure is shown. To this end, the refractive index of the core 101 and the refractive index of the ring 102 are shown as a function of radius for a cylindrical coupled waveguide structure. Moreover, the indices of refraction of the cladding layers 103 between the core 101 and the ring 102, as well as outside the ring 102 is shown. In the illustrative embodiment shown in FIG. 1, the core and ring are made of the same material suitably doped to effect a desired index profile. Alternatively, the core and cladding may be of different materials. Moreover, the indices of refraction of the cladding layers 103 between the core and ring, and outside the ring may be the same, or different than one another. It is further noted that the rings may be of the same, or different materials, and that the indices of refraction of these rings may be the same or different. In the case of multiple rings each ring can have a different refractive index.

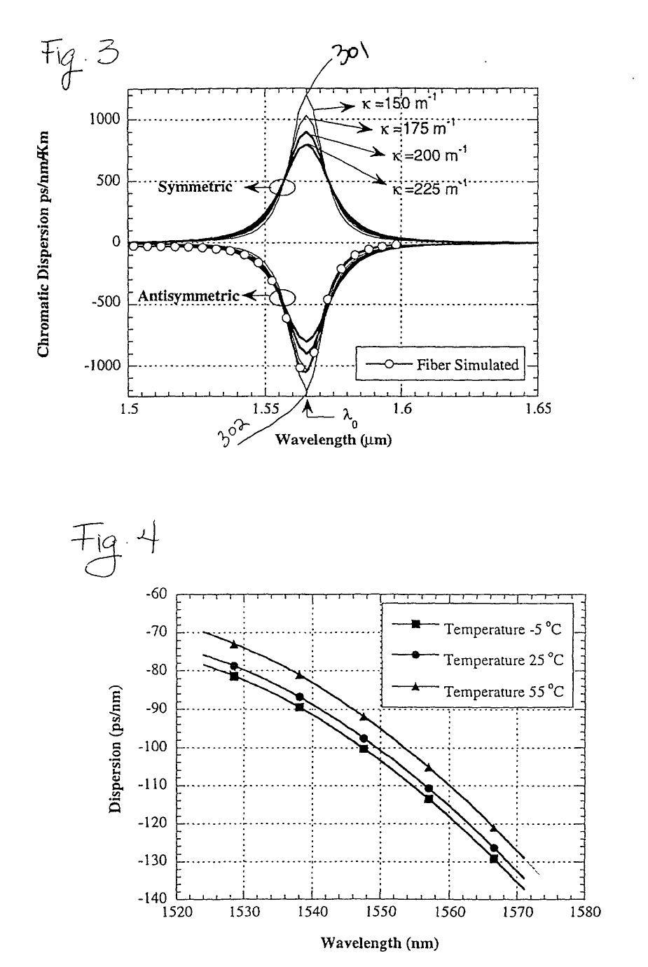

Turning to FIG. 2, a graphical representation of the refractive index versus radius of another coupled waveguide structure is shown. Again, the coupled waveguide structure is illustratively a cylindrical coupled waveguide structure having a core 201, a ring 202 and cladding 203 disposed between the core 201 and ring 202; and outside the ring 202 The core 201 and the ring 202 in this illustrative embodiment are made of different materials. Again, the cladding layers may have the same or different indices or refraction.

In coupled waveguide structures such as those shown graphically in FIGS. 1 and 2, when light is coupled into the core of the waveguide, it can be coupled to the ring under certain conditions, and in a variety of ways. This type of coupling is generally known as directional coupling. Moreover, the eigenmodes of such a coupled waveguide system are referred to as supermodes. Further details of coupled waveguides and supermodes may be found for example in “Optical Electronics” (3^{rd} Edition) by Amnon Yariv, pages 437-447; and in “Diode Laser and Photonic Integrated Circuits”, by Coldren and Corzine, pages 282-287. The disclosure of the referenced materials are specifically incorporated by reference herein and for all purposes.

The dispersion characteristics of the fundamental and first order harmonic supermodes are used to effect dispersion control in accordance with an exemplary embodiment of the present invention.

The coupling between the ring and core causes the dispersion of such coupled optical waveguides to be governed mainly by the waveguide dispersion of the coupled system. Specifically, it can be shown that the group velocity dispersion (chromatic dispersion) may be approximated by:

$${GVD}_{sup {er}_{sym ( + ) , asym ( - )}} = {D}_{0} \pm \frac{1}{4 κ} {{( \frac{1}{{v}_{1}} - \frac{1}{{v}_{2}} )}^{2} [ \frac{{( ω - {ω}_{0} )}^{2}}{4 {κ}^{2}} {( \frac{1}{{v}_{2}} - \frac{1}{{v}_{1}} )}^{2} + 1 ]}^{- 3 / 2} \qquad ( 1 )$$

where GVD is the group velocity dispersion of the symmetric and asymmetric supermodes; ν₁ and ν₂ are the group velocities of the first and second waveguides, respectively, at the angular frequency ω₀ (that corresponds to a wavelength λ₀); and κ is the coupling constant of the guides.

A few points in connection with equation (1) are worthy of discussion presently. First, the coupling coefficient κ can be shown to be proportional to the refractive index profile of the coupled waveguide structure. Moreover, when ω=ω₀, it can be shown that the optical power is coupled with maximum efficiency between the two waveguides. This is known as the resonance condition of the supermode, and occurs when there is no phase velocity differential between the individual waveguide eigenmode velocities. At resonance, the propagated mode experiences a maximum shift in its group velocity, resulting in a relative maximum in the chromatic dispersion. The present invention relates generally to dynamic manipulation of the index of refraction profile to change the chromatic dispersion characteristics as desired.

Turning to FIG. 3, an example of a typical graph of the chromatic dispersion versus wavelength for a variety of coupled waveguide structures having different coupling constants, κ, is shown. At a particular wavelength, λ₀, the chromatic dispersion reaches a minimum peak 302 for the asymmetric eigenmode (fundamental mode), and a maximum peak 301 for the symmetric eigenmode (first order harmonic).

As can be appreciated from a review of FIG. 3, the absolute value of the chromatic dispersion (positive or negative dispersion) is also dependent upon the coupling coefficient κ. Moreover, from a review of equation (1), a change in κ and the group velocities, ν₁ and ν₂, will result in a change in the values around the wavelength λ₀. It follows, therefore, that a small change in the index of refraction of the core, ring or cladding (or a combination thereof) can lead to significant changes in the chromatic dispersion. Changes in the values the dispersion due to changes in the refractive index profile are also associated with shifts in the resonant wavelength. All of these effects that change the dispersion values and shift the resonance are coupled and cannot be disassociated when the profile is changed. In particular, changes in the index of refraction can result in a shift of the curves along the abscissa (wavelength axis) of the graph shown in FIG. 3.

Finally, it is noted that the dispersion slope (change in dispersion per unit change in wavelength) can be controllably altered by altering the index of refraction profile. As is known, dispersion slope impairments can adversely impact signal transmission. Dispersion slope impairments may result from optical waveguide (e.g. fiber) dispersion slope; dispersion slope from optical components and equipment in the optical transmission system; and from thermal fluctuations, which can alter dispersion slope. The control and correction of dispersion slope becomes increasingly important for high transmission rate systems operating with certain transmission formats. For instance, 40 Gbps optical networks using RZ formats can be degrades when the received optical signal has 100 ps/nm² or more of chromatic dispersion slope.

Accordingly, one advantage of the present invention as described in connection with exemplary embodiments is the capability to control the dispersion slope of an optical signal. The dispersion slope may be adjusted to zero (nullified), or may be adjusted so the net dispersion slope in the optical signal is positive or negative.

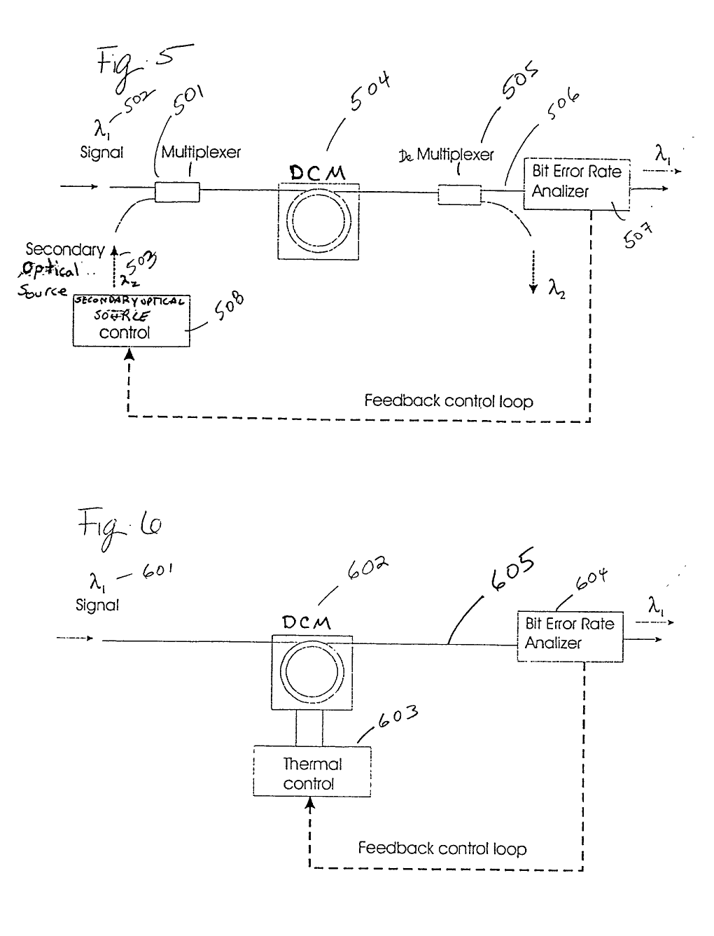

Turning to FIG. 4, a graph of experimentally measured chromatic dispersion versus wavelength for a coupled waveguide structure having a core and ring configuration in accordance with an exemplary embodiment of the present invention is shown for various temperatures. The coupled waveguide used in this exemplary embodiment is not the same as that having dispersion characteristics shown in FIG. 3, but follows the same physical principles described. In particular, the chromatic dispersion of a core and ring coupled waveguide structure as previously described exhibits a wavelength dependence, which is also temperature dependent. Again, the change in temperature results in a change in the index of refraction profile for the coupled waveguides, which is manifest in a temperature dependence of the chromatic dispersion.

The drift in dispersion with temperature may be increased by using a coupled waveguide structure having the core and the ring made of different materials. In this case, depending upon the coefficients of variation of refractive index of the material with temperature, higher drift efficiencies can be achieved. The variation can be made more efficient if the coefficients of the variation of refractive index with temperature have opposite sign. For example, if the variation of index of refraction of the core with temperature is positive and the variation of the index of refraction of the ring with temperature is negative, the effects are more pronounced. Again, it is noted that the cladding material may be made of the same or different material than the core and/or the ring of the coupled waveguide. Moreover, it is noted that if more than one ring (and therefore more than one cladding layer) is incorporated into the coupled waveguide structure, the refractive indices of the subsequent ring(s) are not necessarily the same.

As referenced previously, altering the temperature of the coupled waveguide structure is one way to alter its dispersion characteristics. Another method involves the use of a secondary optical energy source. Illustratively, a secondary source of optical power may be input to the coupled waveguide structure resulting in nonlinear effects that can lead to a shift in the resonance wavelength. To this end, the refractive index of a material as a function of frequency varies with the intensity of the applied optical source. Specifically:

ñ(ω,|E|²)=n(ω)+n₂|E|² (2)

where ñ is the refractive index as a function of angular frequency ω and intensity of the optical source, |E|²; n₂ is the nonlinear refractive index of the material, and E is the electrical field component of the light propagating in the waveguide.

It is noted that although the energy of the optical signal is substantially evenly distributed between the core and the ring waveguides in the coupled waveguide system, in the case of excitation by a secondary optical source, it can be shown that for wavelengths above the resonant wavelength, λ₀, most of the power will be concentrated in the ring. Therefore, depending on the wavelength of the pump and the optical signal traversing the fiber, different parts of the waveguide, namely the core and the ring, may be excited discreetly. This enhances the refractive index of one part of the waveguide while the refractive index of the other, which substantially does not couple radiation of the secondary source, remains substantially unchanged.

As can be appreciated, using the illustrative secondary optical source method, all-optical control of chromatic dispersion is feasible if the waveguide is designed to operate close to the resonance wavelength, and proper materials and optical power are chosen. This can be observed again in FIG. 3, where illustrative waveguide structures have a resonance wavelength around 1.56 μm, with high dispersion values. In accordance with an exemplary embodiment of the present invention, typical changes in refractive index for achieving tunable devices are between 1×10⁻⁶ to 1×10⁻², depending on the dispersion values around the resonance.

In addition, the all-optical power control may be more highly enhanced by the use of different materials in the core and in the ring, as described previously. In this case, materials with different nonlinear refractive indices n₂ can increase the shift in λ₀ with optical power leading to a higher drift in the dispersion values. Finally, as can be readily appreciated, because chromatic dispersion is given in units of ps/nm-km, the fiber length can be long or short depending on the fiber design, and degree of dispersion control desired. In practical deployment, the fiber can be a straight length of relatively short fiber, or a coiled longer length of fiber.

It is further noted that the dynamic alteration of the index of refraction profile of the coupled waveguide optical fiber in accordance with the exemplary embodiments of the present invention may be effected by a combination of thermal control and secondary source optical power control. Also the use of pressure (external force), electric field in electroopic materials used as dopants in the fiber, and acoustic waves with use of elastooptic coefficients can be used as to dynamically alter the index of refraction profile of a coupled waveguide structure. A combination of these techniques potentially offers a wider range of control.

FIG. 5 shows a dynamic dispersion control apparatus using all optical control in accordance with an exemplary embodiment of the present invention. A multiplexer 501 is used to couple the input optical signal 502 with a secondary optical source 503. Illustratively, the secondary optical source is laser. Of course, other optical sources may be used for the secondary optical source.

The signals are input to a dispersion control module (DCM) 504 which includes one or more coupled waveguide structure. The coupled waveguide structure(s) can be illustratively the coupled waveguide optical fiber having the core and ring configuration described above. A demultiplexer 505 is used to split off the output optical signal 506. Any chromatic dispersion present in the output optical signal 506 has been selectively adjusted to a desired extent via an exemplary embodiment of the present invention. A bit-error rate (BER) analyzer 507 or similar system performance monitor may be used in a feedback control loop. The BER analyzer may be used to analyze the correction/adjustment to the chromatic dispersion in the output signal 506. Based on the feedback from the BER analyzer, a secondary optical source controller 508 can dynamically adjust the output power from secondary optical source 503 to the DCM 504. This dynamic adjustment in the output power from the secondary optical source 503 results in a dynamically controlled adjustment of the chromatic dispersion and/or dispersion slope in an output optical signal 506.

In accordance with an exemplary embodiment of the present invention, using all optical control, illustrative changes in refractive index for achieving tunable devices in accordance with an exemplary embodiment are in the range of approximately 1×10⁻⁶ to approximately 1×10⁻², depending on the dispersion values around the resonance wavelength. Changes in dispersion values in the optical signal in accordance with an exemplary embodiment can be in the range of approximately −100000 ps/nm to approximately +100000 ps/nm depending on the profile used. According to another illustrative embodiment, the changes in dispersion values using a DCM coupled to a secondary optical source are in the range of approximately −20000 ps/nm to approximately +20000 ps/nm.

The optical power supplied by the secondary optical source signal 503 to achieve dispersion control is illustratively in the range of approximately 0.001 mW to approximately 1KW. The wavelength of the secondary optical source signal is illustratively in the range of approximately 0.01 μm to approximately 100 μm.

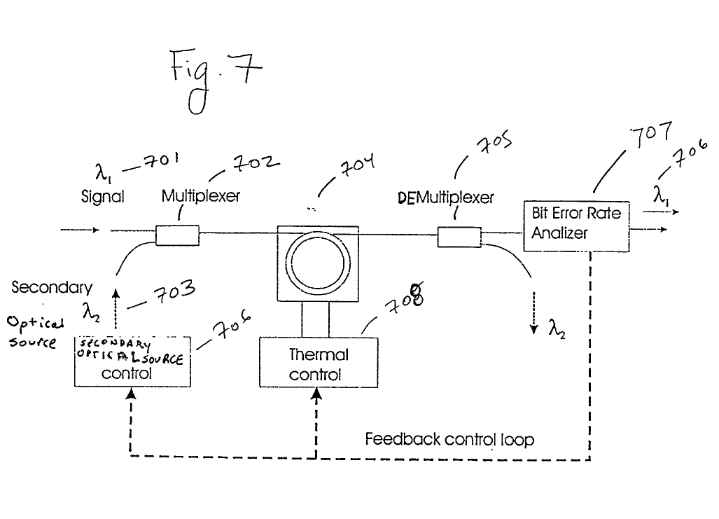

FIG. 6 shows a dynamic dispersion control apparatus in accordance with an exemplary embodiment of the present invention using all thermal control. An input optical signal 601 is incident upon a dispersion control module (DCM) 602, which includes at least one coupled waveguide structure such as an optical fiber having a core and ring as described above. The temperature of the DCM 602 is controlled by thermal controller 603. A bit-error rate analyzer 604 or similar system performance monitor may be used in a feedback control loop. Based on the feedback from the BER analyzer, the thermal controller 603 may dynamically effect changes in the temperature of the coupled waveguide structure(s) of the DCM. This dynamic adjustment in the temperature by the thermal results in a dynamically controlled adjustment of the chromatic dispersion and/or dispersion slope in an output optical signal 605.

In accordance with an exemplary embodiment of the present invention, using thermal control, changes in refractive index for achieving tunable devices in accordance with an exemplary embodiment of the present invention are in the range of approximately 1×10⁻⁶ to approximately 1×10⁻², depending on the dispersion values around the resonance wavelength. In accordance with an exemplary embodiment, changes in dispersion values in an optical signal can be in the range of approximately −100000 ps/nm to approximately +100000 ps/nm depending on the profile used.. According to another illustrative embodiment, the changes in dispersion values using a DCM coupled to a secondary optical source are in the range of approximately −20000 ps/nm to approximately +20000 ps/nm.

Temperature variations effected by the thermal controller 603 to achieve dispersion control are illustratively in the range of approximately −100° C. to approximately +100° C.

Finally, turning to FIG. 7, a combination of optical power control and thermal control is used to effect dispersion control in accordance with an exemplary embodiment of the present invention. An input signal 701 is incident upon a multiplexer 702 where it is combined the output from a secondary optical source 703. The combined signal is input to a DCM 704, which includes at least one coupled waveguide structure therein. The temperature of the DCM 704 is controlled by a thermal controller 708. The output of the DCM 704 is input to a demultiplexer 705. A BER analyzer 707 or other suitable device is used in a feedback control loop. The output signal 706 is analyzed by a bit-error rate analyzer 707 to enable changes to be made in the degree of chromatic dispersion control by the DCM 704. These desired changes in the chromatic dispersion may be effected dynamically by changing the temperature of the coupled waveguide structure (s) with thermal controller 708 and/or by changing the input optical power thereto via the secondary optical source controller 706.

It is noted that the various elements and techniques described in connection with the illustrative embodiment of FIG. 7 are substantially identical to those described in conjunction with the exemplary embodiment of FIGS. 5 and 6. To wit, the common elements such as the bit-error rate analyzer 707, the thermal control 708, the secondary optical source 706, and the temperature and secondary optical source parameters are substantially the same as previously described. Likewise, the combined optical power/thermal control dispersion control apparatus of an exemplary embodiment of the present invention, enables changes in refractive index described above.

In accordance with an exemplary embodiment of the present invention using a combination of thermal control and optical control, changes in dispersion values in an optical signal are illustratively in the range of approximately −100000 ps/nm to approximately +100000 ps/nm depending on the profile used. In another exemplary embodiment, the combined techniques results in changes in the chromatic dispersion in an optical signal in the range of approximately −20000 ps/nm to approximately +20000 ps/nm.

Illustratively, temperature variations to achieve dispersion control in the exemplary embodiment are in the range of approximately −100° C. to approximately +100° C.; while optical power from the secondary source is approximately 0.001 mW to approximately 1KW; and wavelengths for the secondary optical signal are in the range of approximately 0.01 μm to approximately 100 μm.

It is further noted that the above referenced alternative techniques for achieving CD control may be used individually or in combination in apparati similar in architecture to those described in connection with the exemplary embodiments of FIGS. 5-7. These alternative techniques may be electrooptic or acoustooptic in nature, and may be used individually or combined with one or more of the techniques described herein.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

We claim:

1. An apparatus for dynamically controlling for chromatic dispersion in an optical signal, comprising:
a coupled waveguide structure; and
a device which alters an index of refraction of said coupled waveguide structure to effect a change in the chromatic dispersion.

2. An apparatus as recited in claim 1, wherein said coupled waveguide structure further comprises a core circumferentially surrounded by at least one ring.

3. An apparatus as recited in claim 2, wherein a cladding layer is disposed between said core and said at least one ring.

4. An apparatus as recited in claim 2, wherein a cladding layer is disposed about said at least one ring.

5. An apparatus as recited in claim 3, wherein said cladding layer further comprises a plurality of individual layers.

6. An apparatus as recited in claim 4, wherein said cladding layer further comprises a plurality of individual layers.

7. An apparatus as recited in claim 2, wherein said core and said at least one ring have the same index of refraction.

8. An apparatus as recited in claim 2, wherein said core and said at least one ring do not have the same index of refraction.

9. An apparatus as recited in claim 1, wherein said coupled waveguide structure is a planar waveguide structure.

10. An apparatus as recited in claim 1, wherein said device further comprises a source to controllably heat and cool said coupled waveguide structure.

11. An apparatus as recited in claim 1, further comprising a feedback control loop which is adapted to control said device in order to effect a desired change in the chromatic dispersion of the optical signal.

12. An apparatus as recited in claim 11, wherein said feedback control loop further comprises a bit-error rate analyzer which receives a portion of an output from the apparatus.

13. An apparatus as recited in claim 1, wherein said device farther comprises a secondary source of optical power which selectively couples to said coupled waveguide structure.

14. An apparatus as recited in claim 13, wherein said feedback control loop further comprises a bit-error rate analyzer which receives a portion of an output from the apparatus.

15. An apparatus as recited in claim 1, wherein said device farther comprises a source to controllably heat and cool said coupled waveguide structure and a secondary optical source which selectively couples to said coupled waveguide structure.

16. An apparatus as recited in claim 15, wherein said feedback control loop farther comprises a bit-error rate analyzer which receives a portion of an output from the apparatus.

17. An apparatus as recited in claim 1, wherein the apparatus dynamically controls dispersion slope.

18. An apparatus as recited in claim 1, wherein the dynamic controlling of chromatic dispersion results in zero chromatic dispersion in the optical signal.

19. An apparatus as recited in claim 1, wherein the dynamic controlling of chromatic dispersion results in positive chromatic dispersion in the optical signal.

20. An apparatus as recited in claim 1, wherein the dynamic controlling of chromatic dispersion results in negative chromatic dispersion in the optical signal.

21. An apparatus as recited in claim 17, wherein said dynamic control of dispersion slope results in zero dispersion slope in the optical signal.

22. An apparatus as recited in claim 17, wherein said dynamic control of dispersion slope results in positive dispersion slope in the optical signal.

23. An apparatus as recited in claim 17, wherein said dynamic control of dispersion slope results in negative dispersion slope in the optical signal.

24. An apparatus as recited in claim 1, wherein said device is chosen from the group consisting essentially of: a source to controllably heat and cool said coupled waveguide structure; a secondary optical source which selectively couples to said coupled waveguide structure; an electrooptic effect device; and an acoustooptic effect device.

25. An apparatus as recited in claim 24, wherein said feedback control loop further comprises a bit-error rate analyzer which receives a portion of an output from the apparatus.

26. An apparatus as recited in claim 1, wherein a change in chromatic dispersion in the optical signal is in the range of approximately −100000 ps/nm to approximately +100000 ps/nm.

27. A method for dynamically controlling chromatic dispersion in an optical signal, the method comprising:
providing a coupled waveguide structure; and
selectively altering an index of refraction in said coupled waveguide structure to effect a change in the chromatic dispersion of an optical signal.

28. A method as recited in claim 27, wherein said selective altering further comprises heating and cooling said coupled waveguide structure.

29. A method as recited in claim 27, wherein said selective altering further comprises introducing a secondary optical signal to said coupled waveguide structure.

30. A method as recited in claim 28, wherein said heating and cooling is in a range of approximately −100° C. to approximately +100° C.

31. A method as recited in claim 29, wherein said secondary optical signal has a power in the range of approximately 0.001 mW to approximately 1KW.

32. A method as recited in claim 29, wherein said secondary optical signal has a wavelength in the range of approximately 0.01 μm to approximately 100 μm.

33. A method as recited in claim 27, wherein said selective altering is effected using an electrooptic effect.

34. A method as recited in claim 27, wherein said selective altering is effected using an acoustooptic effect.

35. A method as recited in claim 27, wherein said altering is effected using a technique chosen from the group consisting essentially of: heating and cooling said coupled waveguide structure; introducing a secondary optical signal to said coupled waveguide structure; using an electrooptic effect; and using an acoustooptic effect.

36. A method as recited in claim 27, the method further comprising analyzing a bit-error rate, and controlling the chromatic dispersion based on said analyzing.

37. A method as recited in claim 27, wherein a feedback control loop is used in the method.

38. A method as recited in claim 27, wherein the dynamic controlling of chromatic dispersion results in zero chromatic dispersion in the optical signal.

39. A method as recited in claim 27, wherein the dynamic controlling of chromatic dispersion results in positive chromatic dispersion in the optical signal.

40. A method as recited in claim 27, wherein the dynamic controlling of chromatic dispersion results in negative chromatic dispersion in the optical signal.

41. A method as recited in claim 27, wherein the method further comprises dynamically controlling dispersion slope.

42. A method as recited in claim 41, wherein said dynamical control of dispersion slope results in zero dispersion slope.

43. A method as recited in claim 41, wherein said dynamical control of dispersion slope results in negative dispersion slope.

44. A method as recited in claim 41, wherein said dynamical control of dispersion slope results in positive dispersion slope.
